(19) United States
(12) Patent Application Publication
(10) Pub. No.: US 2021/0001853 A1
(43) Pub. Date: Jan. 7, 2021

(54) E-ISG CONTROL DEVICE AND METHOD FOR VEHICLE

(71) Applicants: HYUNDAI MOTOR COMPANY, Seoul (KR); KIA MOTORS CORPORATION, Seoul (KR)

(72) Inventors: Jung Sup BYUN, Seongnam-si (KR); Seung Woo LEE, Seoul (KR); Chan Hee WON, Seoul (KR); Seong Kyu PARK, Hwaseong-si (KR)

(73) Assignees: HYUNDAI MOTOR COMPANY, Seoul (KR); KIA MOTORS CORPORATION, Seoul (KR)

(21) Appl. No.: 16/654,364

(22) Filed: Oct. 16, 2019

(30) Foreign Application Priority Data
Jul. 1, 2019 (KR) 10-2019-0078877

(51) Int. Cl. B60W 30/18; B60W 10/06; B60W 10/02; B60W 10/18

(52) U.S. Cl. CPC B60W 30/18018; B60W 10/06; B60W 10/02; B60W 2540/12; B60W 2710/021; B60W 2710/0666; B60W 2710/18; B60W 10/18

(57) ABSTRACT

The present disclosure relates to an Extended Idle Stop and Go (E-ISG) control device and method for a vehicle. The E-ISG control device includes a Brake Pedal Sensor (BPS) that outputs an ON signal when a user depresses a brake pedal and outputs an OFF signal when the user does not depress the brake pedal and a controller that stops operation of an engine and opens an electronic clutch when the vehicle is not in N gear during travel and the ON signal is output from the BPS.

### CROSS-REFERENCE TO RELATED APPLICATION

This application claims priority to and the benefit of priority to Korean Patent Application No. 10-2019-0078877, filed in the Korean Intellectual Property Office on Jul. 1, 2019, the entire contents of which are incorporated herein by reference.

### FIELD

The present disclosure relates to a technology for controlling an Extended Idle Stop and Go (E-ISG) system included in a vehicle.

### BACKGROUND

The statements in this section merely provide background information related to the present disclosure and may not constitute prior art.

In general, when a vehicle is in Drive (D) gear in a stop state and a brake pedal is depressed by a driver (hereinafter, referred to as a brake-on state), an Idle Stop and Go (ISG) system stops operation of an engine, thereby improving the fuel economy of the vehicle and reducing exhaust gases.

When the driver releases the brake pedal (hereinafter, referred to as a brake-off state) or depresses an accelerator pedal (hereinafter, referred to as an accelerator-on state) in the state in which the operation of the engine is stopped, the ISG system determines that the driver has an intention to drive the vehicle again and operates the engine again.

The ISG system is a system that stops or restarts the engine only when the vehicle is stopped. However, a recent E-ISG system may stop or restart an engine even during travel of a vehicle when it is determined that a driver has an intention to stop the vehicle.

An E-ISG system in the related art stops operation of an engine when a vehicle is not in Neutral (N) gear during travel, a brake pedal is in an ON state, and a clutch pedal is in an ON state. Furthermore, the E-ISG system in the related art restarts the engine when the vehicle is in N gear and the clutch pedal is changed from an OFF state to an ON state, when the vehicle is not in N gear and the clutch pedal is changed from an OFF state to an ON state, or when the brake pedal is in an OFF state and the clutch pedal is in an ON state.

The E-ISG system in the related art may inconvenience a driver because the driver has to directly turn on/off the clutch pedal. In addition, because the driver has to directly turn off the clutch pedal when engaging the clutch after the engine is restarted, engine torque may not be taken into consideration, and therefore shifting shock may occur.

### SUMMARY

The present disclosure has been made to address the above-mentioned problems occurring in the prior art while advantages achieved by the prior art are maintained intact.

An aspect of the present disclosure provides an E-ISG control device and method for enabling a driver to use an E-ISG function in an easy and simple manner and preventing shifting shock generated when an electronic clutch is engaged, by simplifying a condition for stopping operation of an engine during travel of a vehicle and a condition for a restart of the stopped engine and engaging the electronic clutch in a restricted engine torque state when the engine is restarted.

The technical problems to be addressed by the present disclosure are not limited to the aforementioned problems, and any other technical problems not mentioned herein will be clearly understood from the following description by those skilled in the art to which the present disclosure pertains. Also, it will be easily understood that the aspects and advantages of the present disclosure can be accomplished by the means set forth in the appended claims and combinations thereof.

In one aspect of the present disclosure, an E-ISG control device of a vehicle includes a Brake Pedal Sensor (BPS) that outputs an ON signal when a user depresses a brake pedal and outputs an OFF signal when the user does not depress the brake pedal and a controller that stops operation of an engine and opens an electronic clutch when the vehicle is not in N gear during travel and the ON signal is output from the BPS.

The controller may operate the engine again when the OFF signal is output from the BPS in a state in which the operation of the engine is stopped.

The controller may transmit a torque limit for restricting torque of the engine to an Engine Control Unit (ECU) when the engine is operated again.

The controller may request engagement of the electronic clutch from a Transmission Control Unit (TCU) in a state in which the torque of the engine is restricted.

According to another aspect of the present disclosure, an E-ISG control method for a vehicle includes obtaining gear information from a Transmission Control Unit (TCU), receiving a signal from a Brake Pedal Sensor (BPS), and stopping operation of an engine and opening an electronic clutch when the vehicle is not in N gear during travel and the signal received from the BPS is an ON signal.

The E-ISG control method may further include operating the engine again when an OFF signal is received from the BPS in a state in which the electronic clutch is open.

The E-ISG control method may further include transmitting a torque limit for restricting torque of the engine to an Engine Control Unit (ECU) when the engine is operated again.

The E-ISG control method may further include requesting engagement of the electronic clutch from the TCU in a state in which the torque of the engine is restricted.

Further areas of applicability will become apparent from the description provided herein. It should be understood that the description and specific examples are intended for purposes of illustration only and are not intended to limit the scope of the present disclosure.

### DRAWINGS

The above and other objects, features and advantages of the present disclosure will be more apparent from the following detailed description taken in conjunction with the accompanying drawings:

FIG. 1 is a block diagram of one form of an E-ISG control device of a vehicle;

FIG. 2 is a view illustrating a gain that one form of the E-ISG control device of the vehicle generates in conjunction with an SSC system;

FIG. 3 is a flowchart illustrating one form of an E-ISG control method for a vehicle; and

FIG. 4 is a block diagram illustrating one form of a computing system for executing an E-ISG control method for a vehicle.

The drawings described herein are for illustration purposes only and are not intended to limit the scope of the present disclosure in any way

### DETAILED DESCRIPTION

The following description is merely exemplary in nature and is not intended to limit the present disclosure, application, or uses. It should be understood that throughout the drawings, corresponding reference numerals indicate like or corresponding parts and features.

Hereinafter, some embodiments and implementations of the present disclosure will be described in detail with reference to the exemplary drawings. In adding the reference numerals to the components of each drawing, it should be noted that the identical or equivalent component is designated by the identical numeral even when they are displayed on other drawings. Further, in describing embodiments and implementations of the present disclosure, a detailed description of well-known features or functions will be ruled out in order not to unnecessarily obscure the gist of the present disclosure.

In describing the components of embodiments and implementations according to the present disclosure, terms such as first, second, “A”, “B”, (a), (b), and the like may be used. These terms are merely intended to distinguish one component from another component, and the terms do not limit the nature, sequence or order of the components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

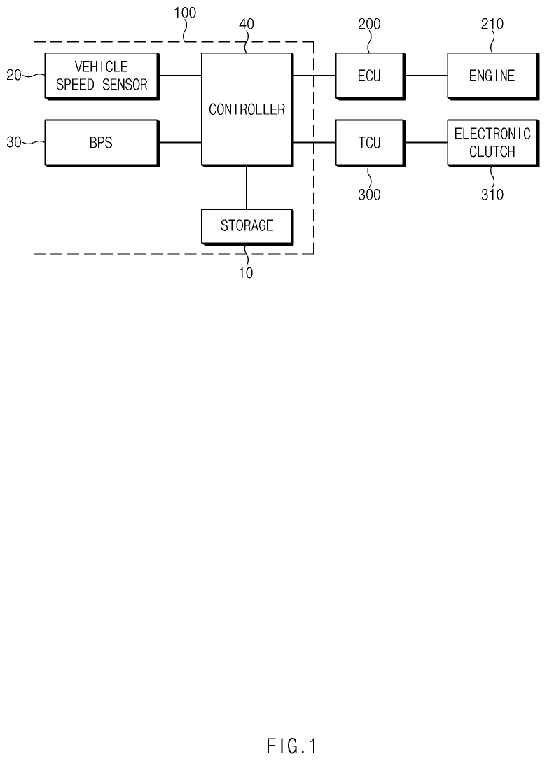

FIG. 1 is a block diagram of one form an E-ISG control device 100 of a vehicle. The vehicle may be equipped with a 48V system included in an additional motor for starting an engine 210 during travel of the vehicle, a brake pedal, an accelerator pedal, a clutch pedal, and a manual gear lever.

As illustrated in FIG. 1, the E-ISG control device 100 of the vehicle may include storage 10, a vehicle speed sensor 20, a Brake Pedal Sensor (BPS) 30, and a controller 40. The components may be combined together to form one entity, or some of the components may be omitted, depending on a way of carrying out the E-ISG control device 100 of the vehicle.

Hereinafter, the aforementioned components will be described in detail. The storage 10 may store various types of logic, algorithms, and programs that are required in a process of simplifying a condition for stopping operation of the engine 210 during travel of the vehicle and a condition for a restart of the stopped engine 210 and engaging an electronic clutch 310 in a restricted engine torque state when the engine 210 is restarted.

The storage 10 may store an engine torque value (hereinafter, referred to as a torque limit) for preventing shifting shock generated when the electronic clutch 310 is engaged.

The storage 10 may include at least one type of storage medium among memories of a flash memory type, a hard disk type, a micro type, and a card type (e.g., a Secure Digital (SD) card or an eXtream Digital (XD) card) and memories of a Random Access Memory (RAM) type, a Static RAM (SRAM) type, a Read-Only Memory (ROM) type, a Programmable ROM (PROM) type, an Electrically Erasable PROM (EEPROM) type, a Magnetic RAM (MRAM) type, a magnetic disk type, and an optical disk type.

The vehicle speed sensor 20 is a module used to recognize whether the vehicle is in a driving state or a stop state. The vehicle speed sensor 20 measures the speed of the vehicle.

The BPS 30 is a sensor for sensing whether the brake pedal included in the vehicle is depressed or not. For example, the BPS 30 outputs an ON signal when a user depresses the brake pedal and outputs an OFF signal when the user does not depress the brake pedal. The BPS 30 may output no signal when the user does not depress the brake pedal.

The BPS 30 may sense the degree to which the brake pedal is depressed. For example, the BPS 30 may output 0% when the brake pedal is not depressed, may output 50% when the brake pedal is depressed halfway, and may output 100% when the brake pedal is fully depressed.

The controller 40 performs overall control to enable the components to normally perform functions thereof. The controller 40 may be implemented in a hardware or software form, or may be implemented in a form in which hardware and software are combined. The controller 40 may preferably be implemented with, but is not limited to, a microprocessor.

In particular, the controller 40 may perform various controls that are required in a process of simplifying a condition for stopping operation of the engine 210 during travel of the vehicle and a condition for a restart of the stopped engine 210 and engaging the electronic clutch 310 in a restricted engine torque state when the engine 210 is restarted.

The controller 40 may obtain gear information from a Transmission Control Unit (TCU) 300. The TCU 300 is module for performing electronic control of a transmission that is mounted in the vehicle and that adjusts a gear ratio of the engine 210. The TCU 300 performs control to engage or open the electronic clutch 310. The engagement of the electronic clutch 310 means a state in which the engine 210 and the transmission are connected with each other, and the opening of the electronic clutch 310 means a state in which the engine 210 and the transmission are separated from each other.

The controller 40 may detect whether the vehicle is in a driving state or a stop state, based on a vehicle speed measured by the vehicle speed sensor 20.

The controller 40 may detect that the brake pedal is depressed by a driver, based on an ON signal from the BPS 30 and may detect that the brake pedal is not depressed, based on an OFF signal from the BPS 30.

When the vehicle is not in N gear and an ON signal is output from the BPS 30, the controller 40 may request an Engine Control Unit (ECU) 200 to stop the engine 210. In response to the request, the ECU 200 stops the engine 210. Furthermore, the controller 40 may request the TCU 300 to open the electronic clutch 310. In response to the request, the TCU 300 opens the electronic clutch 310.

In the state in which the engine 210 is stopped as described above, the controller 40 may request the ECU 200 to operate the engine 210 when an OFF signal is output from the BPS 30. In response to the request, the ECU 200 operates the engine 210 by starting the engine 210 through a starter motor (not illustrated).

Thereafter, the controller 40 transmits a torque limit for restricting the torque of the engine 210 to the ECU 200. The ECU 200 controls the engine 210 not to generate torque more than the torque limit.

Thereafter, the controller 40 may request engagement of the electronic clutch 310 from the TCU 300. Shifting shock generated when the electronic clutch 310 is engaged may be prevented through the above-described process.

Meanwhile, the controller 40 may further improve the fuel economy of the vehicle in conjunction with a Start Stop Control (SSC) system included in the vehicle.

In general, the SSC system improves the fuel economy of the vehicle by stopping the engine 210 when the vehicle coasts and restarting the stopped engine 210 when the driver depresses the accelerator pedal.

When the driver depresses neither the brake pedal nor the accelerator pedal, the SSC system determines that the vehicle is coasting, and stops the engine 210. Furthermore, when the driver depresses the accelerator pedal, the SSC system determines that the driver has an intention to drive the vehicle, and restarts the engine 210.

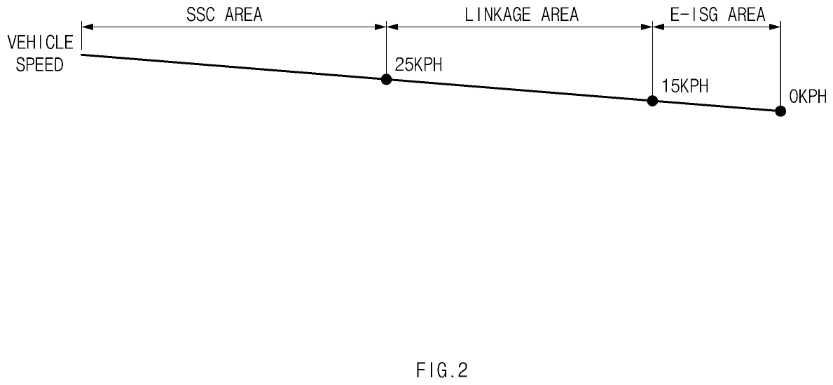

Hereinafter, a gain that the E-ISG control device 100 of the vehicle in conjunction with the SSC system will be described in detail with reference to FIG. 2.

FIG. 2 is a view illustrating a gain that one form of the E-ISG control device 100 of the vehicle generates in conjunction with the SSC system.

As illustrated in FIG. 2, when the driver expresses an intention to stop the vehicle by depressing the brake pedal at a vehicle speed of 25 KPH or less during travel of the vehicle in an SCC area with the engine 210 of the vehicle stopped, an SCC function is linked with an E-ISG function and switched to the E-ISG function. At this time, opening the electronic clutch 310 does not have to be considered in the E-ISG function because the electronic clutch 310 is opened by the SSC function.

Consequently, it can be seen that the fuel economy of the vehicle is further improved through the easy linkage between the SSC function and the E-ISG function.

In some implementations, the E-ISG control device 100, the ECU 200, the engine 210, the TCU 300, and the electronic clutch 310 of the vehicle may be collectively referred to as an E-ISG system.

In some implementations, the controller 40 may be integrated into the ECU 200 or the TCU 300.

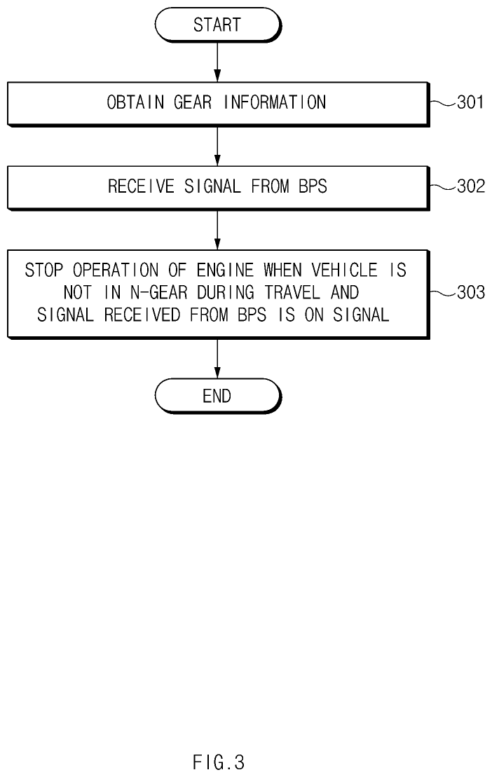

FIG. 3 is a flowchart illustrating one form of an E-ISG control method for a vehicle.

First, the controller 40 obtains gear information from the TCU 300 (301).

Next, the controller 40 receives a signal from the BPS 30 (302).

Then, the controller 40 stops operation of the engine 210 when the vehicle is not in N gear during travel and the signal received from the BPS 30 is an ON signal (303). At this time, the controller 40 may open the electronic clutch 310 in addition to stopping the operation of the engine 210.

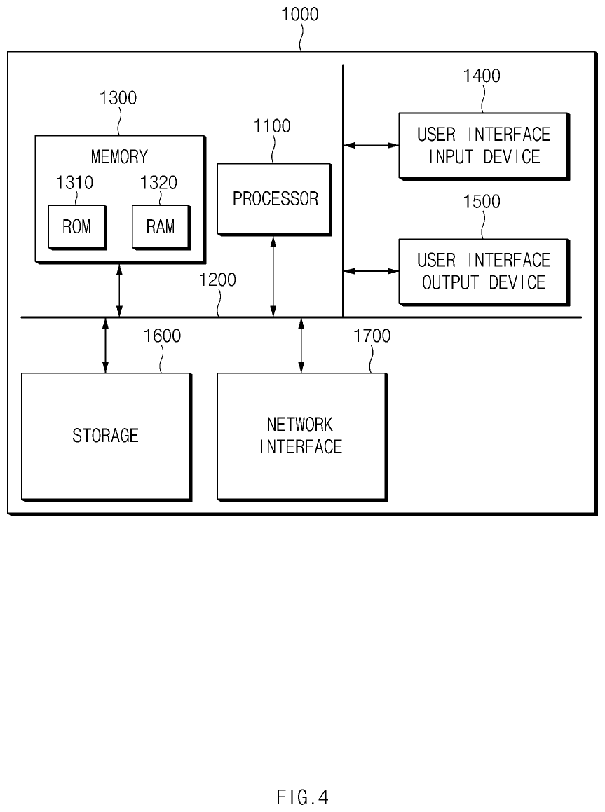

FIG. 4 is a block diagram illustrating one form of a computing system 1000 for executing forms of the E-ISG control method for the vehicle.

Referring to FIG. 4, forms of the E-ISG control method for the vehicle may be implemented through the computing system 1000. The computing system 1000 may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Thus, the operations of the method or the algorithm described in connection with the embodiments disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, or a CD-ROM. The exemplary storage medium may be coupled to the processor 1100, and the processor 1100 may read information out of the storage medium and may record information in the storage medium. Alternatively, the storage medium may be integrated with the processor 1100. The processor 1100 and the storage medium may reside in an application specific integrated circuit (ASIC). The ASIC may reside within a user terminal. In another case, the processor 1100 and the storage medium may reside in the user terminal as separate components.

The E-ISG control device and method for the vehicle according to embodiments and implementations of the present disclosure may simplify a condition for stopping operation of the engine during travel of the vehicle and a condition for a restart of the stopped engine and may engage the electronic clutch in a restricted engine torque state when the engine is restarted, thereby enabling the driver to use an E-ISG function in an easy and simple manner and preventing shifting shock generated when the electronic clutch is engaged.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the exemplary embodiments and implementations of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

What is claimed is:

1. An Extended Idle Stop and Go (E-ISG) control device of a vehicle comprising:
a Brake Pedal Sensor (BPS) configured to output an ON signal when a user depresses a brake pedal and output an OFF signal when the user does not depress the brake pedal; and
a controller configured to stop operation of an engine and open an electronic clutch when the vehicle is not in neutral (N) gear during travel and the ON signal is output from the BPS.

2. The E-ISG control device of claim 1, wherein the controller is configured to operate the engine again when the OFF signal is output from the BPS in a state in which the operation of the engine is stopped.

3. The E-ISG control device of claim 2, wherein the controller is configured to transmit a torque limit for restricting torque of the engine to an Engine Control Unit (ECU) when the engine is operated again.

4. The E-ISG control device of claim 3, wherein the controller is configured to request engagement of the electronic clutch from a Transmission Control Unit (TCU) in a state in which the torque of the engine is restricted.

5. An Extended Idle Stop and Go (E-ISG) control method for a vehicle comprising:
obtaining, with a controller, gear information from a Transmission Control Unit (TCU);
receiving, with the controller, a signal from a Brake Pedal Sensor (BPS); and
stopping, with the controller, operation of an engine and opening an electronic clutch when the vehicle is not in neutral (N) gear during travel and the signal received from the BPS is an ON signal.

6. The E-ISG control method of claim 5, further comprising:
operating, with the controller, the engine again when an OFF signal is received from the BPS in a state in which the electronic clutch is open.

7. The E-ISG control method of claim 6, further comprising:
transmitting, with the controller, a torque limit for restricting torque of the engine to an Engine Control Unit (ECU) when the engine is operated again.

8. The E-ISG control method of claim 7, further comprising:
requesting, with the controller, engagement of the electronic clutch from the TCU in a state in which the torque of the engine is restricted.
